(19) United States
(12) Patent Application Publication
(10) Pub. No.: US 2009/0244505 A1
(43) Pub. Date: Oct. 1, 2009

(54) POSITIONING UNIT OF OPTICAL ELEMENT, OPTICAL SYSTEM, EXPOSURE APPARATUS, ADJUSTMENT METHOD OF OPTICAL SYSTEM

(75) Inventor: Makoto Mizuno, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/413,335

(22) Filed: Mar. 27, 2009

(30) Foreign Application Priority Data
Mar. 28, 2008 (JP) 2008-088793

(51) Int. Cl. G03B 27/70; G02B 7/182; G03B 27/32

(52) U.S. Cl. 355/66; 359/221.2; 355/77

(57) ABSTRACT

A positioning unit is configured to position an optical element in a barrel, and includes a holder configured to hold the optical element, a first intermediate plate mounted with the holder, a second intermediate plate configured to support the first intermediate plate, a plurality of drivers each configured to drive the second intermediate plate with respect to a plurality of axes, and each fixed inside of the barrel, and a positioning part configured to position the first intermediate plate relative to the second intermediate plate, wherein the second intermediate plate couples ends of the plurality of drivers with one another.

### BACKGROUND OF THE INVENTION

1. Field of the Invention

The present invention relates to a positioning unit of an optical element, an optical system, an exposure apparatus, and an adjustment method of an optical system.

2. Description of the Related Art

An exposure apparatus configured to project a pattern of an original (mask) onto a substrate via a projection optical system is increasingly required to improve the resolution. Therefore, an EUV exposure apparatus has recently been proposed which uses a light source that employs the extreme ultraviolet (“EUV”) light having a small wavelength. The high resolution also requires reductions of an aberration and a distortion of the projection optical system.

In order to reduce the aberration and the distortion of the projection optical system, Japanese Patent Laid-Open No. (“JP”) 2005-276933 proposes a positioning unit configured to move an optical element in the projection optical system along an optical axis (coaxially), to tilt it, or to move it in a direction orthogonal to the optical axis.

As other prior art, JP 2004-327529, and “Foundations of Ultraprecision Mechanism Design,” S.T. Smith, Gordon and Breach Science Publishers (2000) ISBN: 2881248403, page 55 propose an example of a kinematic mount.

JP 2005-276933, however, requires both the optical element and the positioning unit to be taken out of the barrel, in correctively processing a shape of an optical element based on a result of an inspection result of an imaging characteristic after the barrel is wholly assembled. In order to take out the positioning unit, the barrel needs a large opening or to be configured dividable. The former method lowers the barrel's rigidity, and causes the barrel or finally the optical element to easily vibrate and to deteriorate the imaging characteristic. On the other hand, the latter method has a difficulty in precisely attaching the optical element to the same position as the pre-takeout position when the optical element that has been correctively processed is assembled back to the barrel. As a result, the latter method has a problem in that the imaging characteristic is less likely to improve due to the assembly adjustment.

JP 2004-327529 teaches to detachably hold a holding element via a kinematic mount at a tip of each of a plurality of rough movement drivers fixed onto a barrel. Nevertheless, in re-attaching the holding element to the tip of the rough movement driver after the attachment and the detachment, a positional relationship at the tip of each rough movement driver changes and the reproducible positioning becomes difficult.

### SUMMARY OF THE INVENTION

The present invention provides a positioning unit, an optical system, an exposure apparatus, and an adjustment method of an optical system, which can easily improve an imaging characteristic.

A positioning unit according to one aspect of the present invention is configured to position an optical element in a barrel, and includes a holder configured to hold the optical element, a first intermediate plate mounted with the holder, a second intermediate plate configured to support the first intermediate plate, a plurality of drivers each configured to drive the second intermediate plate with respect to a plurality of axes, and each fixed inside of the barrel, and a positioning part configured to position the first intermediate plate relative to the second intermediate plate. The second intermediate plate couples ends of the plurality of drivers with one another.

Further features of the present invention will become apparent from the following description of exemplary embodiments with reference to the attached drawings.

### BRIEF DESCRIPTION OF THE DRAWINGS

FIG. 1 is an optical path diagram of an exposure apparatus according one embodiment of the present invention.

FIG. 2 is a partially perspective view of a projection optical system shown in FIG. 1.

FIG. 3 is a perspective view of holders in a positioning unit and an optical element shown in FIG. 2.

FIG. 4 is a perspective view of the positioning unit shown in FIG. 2.

FIG. 5 is a partially exploded perspective view of the positioning unit shown in FIG. 4.

FIG. 6 is a partially exploded perspective view of the positioning unit.

FIG. 7 is a sectional view taken along “A surface” shown in FIG. 2.

FIG. 8 is a flowchart for explaining an adjustment method of the projection optical system shown in FIG. 1.

### DESCRIPTION OF THE EMBODIMENTS

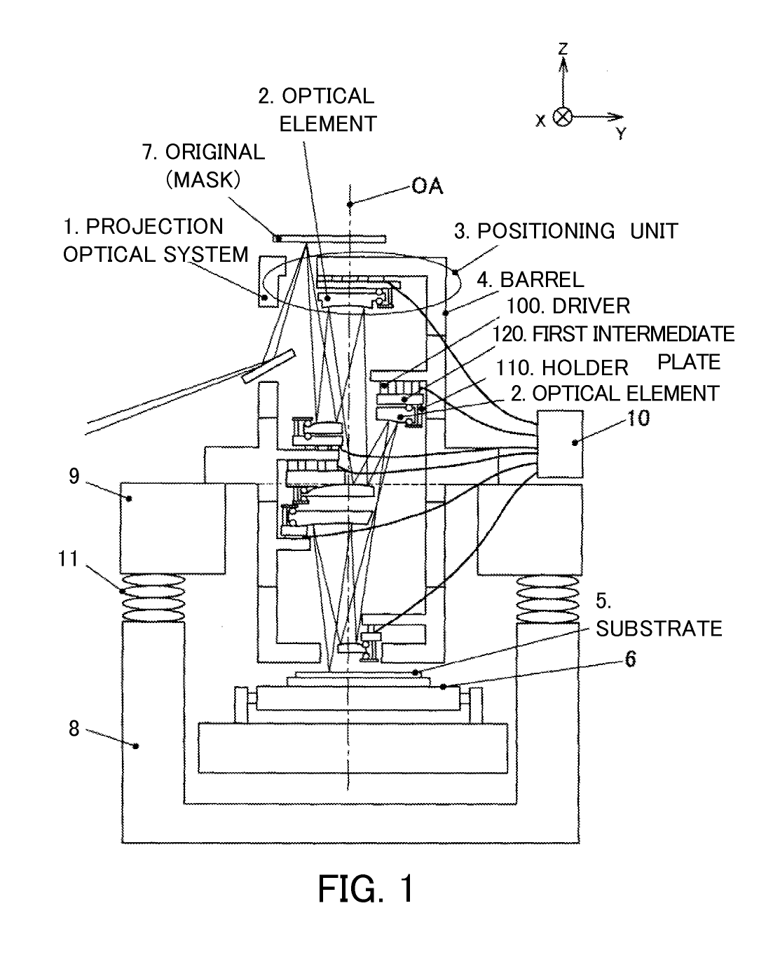

FIG. 1 is an optical path diagram of an exposure apparatus according to this embodiment. This exposure apparatus is a projection exposure apparatus configured to expose a pattern of an original 7, such as a reticle, onto a substrate 5, such as a wafer, using the EUV light as illumination light for exposure and a step-and-scan manner. Alternatively, the exposure apparatus can adopt a step-and-repeat manner. The light source can be another light source, such as a KrF excimer laser, an ArF excimer laser, an F₂ laser, instead of the EUV light source. The exposure apparatus includes an illumination apparatus (not shown), an original stage (not shown) configured to support and drive the original 7, a substrate stage 6 configured to support and drive the substrate 5, and a projection optical system 1 configured to project an image of a pattern of the original onto the substrate 5. Since the transmittance of the EUV light to the air is low, at least an optical path for the EUV light to pass (or the entire optical system) is maintained to be a vacuum atmosphere.

The illumination apparatus illuminates the original 7 by using the EUV light, and includes a light source (not shown) and an illumination optical system (not shown). The light source uses, for example, a laser plasma light source. The illumination optical system uniformly illuminates the original (via an arc-shaped slit in this embodiment).

The original 7 is a reflection type, and has a circuit pattern to be transferred. The original 7 is supported and fixed onto the original stage via an electrostatic chuck, etc., and driven as one united body with the original stage. The diffracted light emitted from the original 7 is reflected on the projection optical system 1, and projected onto the substrate 5. The original 7 and the substrate 5 are arranged in an optically conjugate relationship. The substrate 5 is an object to be exposed, such as a wafer and a liquid crystal substrate, and a photoresist is applied onto it. The substrate stage 6 supports the substrate 5 via a chuck. The original 7 and the substrate 5 are synchronously scanned.

The projection optical system 1 projects a reduced image of the pattern of the original onto the substrate 5 that is located on the image plane, by using the optical elements 2 as a plurality of (multilayer) mirrors. The optical element 2 is positioned in a barrel 4 by a positioning unit 3. The barrel 4 houses the optical element 2 and the positioning unit 3, and its inside is maintained vacuum. The barrel 4 has openings 160 and 162. The opening 160 is dimensioned so that the optical element 2, a plurality of holders 110, and a first intermediate plate 120 in one united body can be put in and out through the opening 160. However, the opening 160 is too small to put in and out the entire positioning unit 3 or a combination of the second intermediate plate 125 and a plurality of drivers in one united body through the opening 160. Since the opening 160 is too small for the entire positioning unit to pass through, this embodiment does not problematically lower the rigidity of the barrel 4, or cause the barrel 4 and finally the optical element 2 to easily vibrate and to deteriorate the imaging characteristic due to external vibrations, unlike JP 2005-276933, supra. The opening 162 is an opening for the exposure light to pass through. If necessary, the barrel 4 may have an opening for an operator to put his hand in, but the opening 160 may serve as an opening for the operator to put his hand in.

A barrel stool 9 and a base frame 8 are fastened with each other via vibration isolation mechanisms 11 so as not to transmit the vibrations of the installation floor to the projection optical system 1.

Reference numeral 10 denotes a controller for the positioning unit 3. The controller 10 controls driving of the optical element 2 based on a pre-stored program so as to minimize an error, such as an aberration and a magnification error obtained from the alignment information, and the controller 10 optimizes the imaging characteristic of the projection optical system 1.

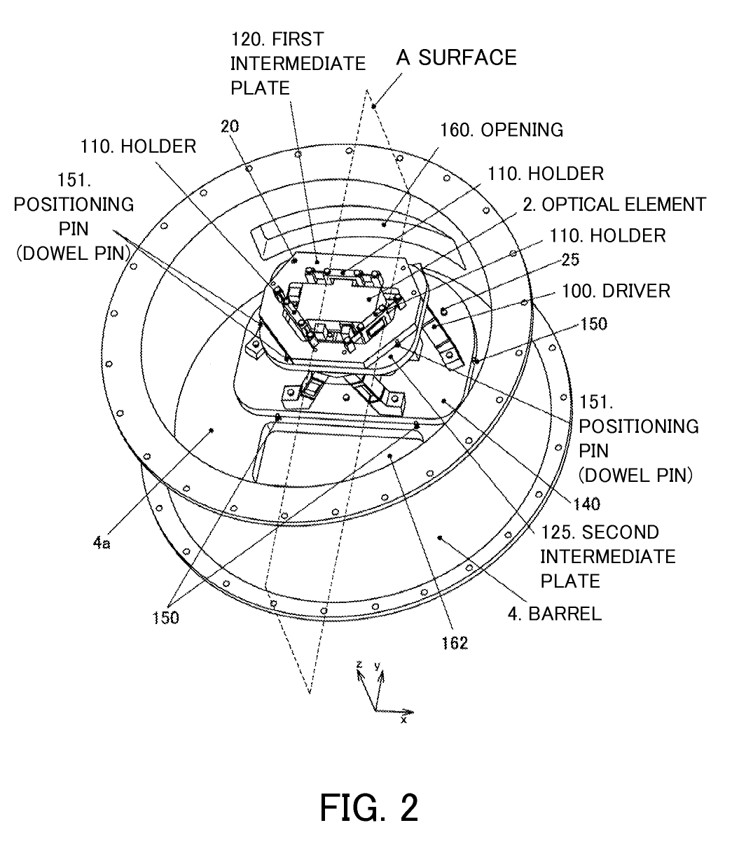

FIG. 2 is a perspective view of part of the projection optical system 1 shown in FIG. 1, or one illustrative positioning unit 3. The positioning unit 3 positions the optical element 2 inside of the barrel, and includes a plurality of holders 110, a first intermediate plate 120, a second intermediate plate 125, a plurality of drivers 100, a positioning part, a plurality of bolts 20, a position measurement part 130 (not shown in FIG. 2), and a base plate 140.

A plurality of (three in this embodiment) holders hold the optical element 2. Each holder 110 intends to mitigate deformations of the optical element 2 due to disturbance and assembly, and is configured between the first intermediate plate 120 and the optical element 2.

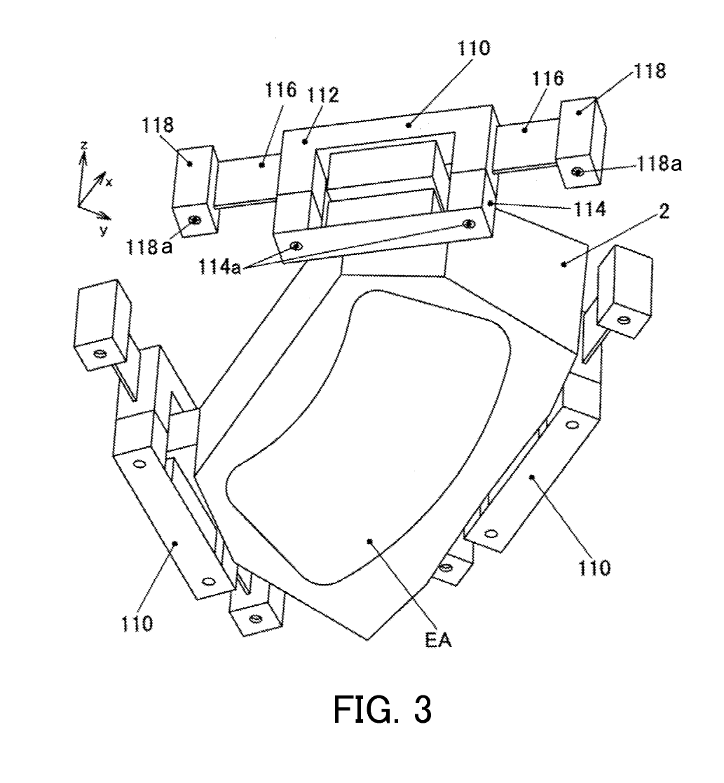

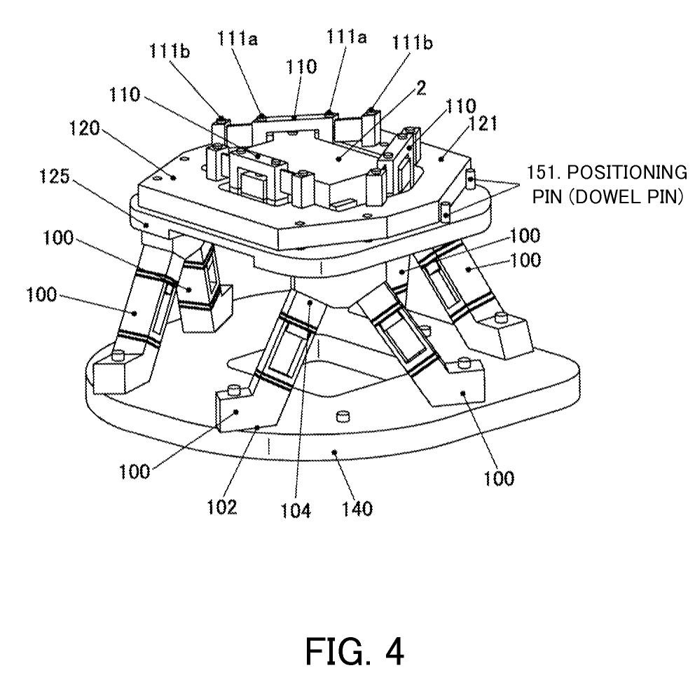

FIG. 3 is a perspective view of one illustrative holder 110. This embodiment arranges, as shown in FIG. 3, the holders 110 at intervals of approximately 120° around the optical element 2. The holders 110 are attached to the side surface of the optical element 2 so as not to shield an effective area EA of the optical element 2. The holder 110 includes a pair of U-shaped fixing parts 112 and 114, a pair of vanes 116 that extend from both side surfaces of the fixing part 112, and a pair of fixing part 118 fixed onto the ends of the pair of vanes 116. The fixing parts 112 and 114 are arranged so that their concaves face each other, and hold the end of the optical element 2 between them. The fixing parts 112 and 114 have bolt holes 114a into which bolts 111a shown in FIG. 4 are inserted (although the bolt holes of the fixing part 112 are not shown), and are integrated with and fixed onto each other via bolts 111a. Thereby, the optical element 2 is fixed by the holders 110. The fixing parts 118 has bolt holes 118a into which bolts 111b shown in FIG. 4 are inserted, and are fixed onto a surface 121 of the first intermediate plate 120 by the bolts 111b.

The first intermediate plate 120 is a platy member mounted with a plurality of holders 110, and it can be put in and out of the barrel 4 while mounted with a plurality of holders 110 and the optical element 2. The second intermediate plate 125 is a platy member configured to support the first intermediate plate 120, and is fixed onto another end 104 of each driver 100 that is fixed onto the base plate 140 that is fixed inside of the barrel 4. Prior art use an intermediate plate as a single platy member, whereas this embodiment uses two separate intermediate plates. The first intermediate plate 120 can be attached to and detached from the barrel 4. The second intermediate plate 125 can change its orientation but its position is fixed in the barrel 4. If the entire positioning unit is put in and out of the barrel, positioning of the positioning unit is necessary after the positioning unit is again mounted onto the barrel. On the other hand, this embodiment dispenses with positioning of the positioning unit by positioning, inside of the barrel 4 the second intermediate plate 125 that is a part of the positioning unit 3.

A plurality of (fixing parts) bolts 20 fix the first intermediate plate 120 onto the second intermediate plate 125.

A plurality of (three in this embodiment) drivers 100 drive the second intermediate plate 125 with respect to a plurality of axes (totally six axes including three axes and rotational axes around respective axes in this embodiment). Each driver 100 uses a Stewart platform type parallel linkage for hexaxial driving. The driver 100 is a movable part configured to adjust positions of the optical element 2, the holders 110, the first intermediate plate 120, and the second intermediate plate 125 in directions of a plurality of axes. The projection optical system 1 can obtain an optimal imaging characteristic when a position of the optical element 2 is precisely adjusted.

One end 102 (shown in FIG. 4) of each driver 100 is fixed onto the base plate 140 fixed inside of the barrel. The second intermediate plate 125 maintains orientations of a plurality of drivers, and thus secures the positioning precision when the first intermediate plate 120 is detached from the second intermediate plate 125 and then re-attached to it. The second intermediate plate 125 couples (other) ends 104 of a plurality of drivers 100 with one another. FIG. 4 shows these ends 104. Since the second intermediate plate 125 couples (other) ends 104 of a plurality of drivers 100 with one another, a positional relationship or an orientation among a plurality of drivers 100 is maintained. If the second intermediate plate 125 does not couple the ends 104 of a plurality of drivers 100 with one another and the plurality of drivers 100 have free ends, it becomes difficult to maintain the positional relationship or the orientation among a plurality of drivers 100.

The positioning part positions the first intermediate plate 120 relative to the second intermediate plate 125, and includes a kinematic mount and/or a positioning pin (or a dowel pin), which will be described later.

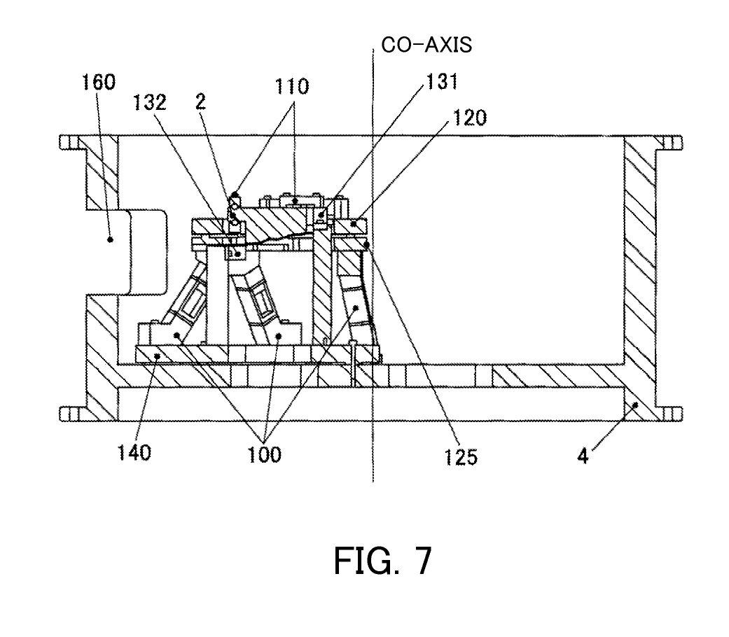

The position measurement part 130 is a sensor configured to measure a position of the optical element 2, and includes, as will be described later with reference to FIG. 7, a sensor head 131 for a horizontal direction and a sensor head 132 for a perpendicular direction. The base plate 140 is positioned onto a diaphragm 4a in the barrel 4 via positioning pins (dowel pins) 150, and fixed onto it via the bolts 25.

An optical characteristic of the projection optical system 1 is inspected after it is provisionally assembled. When it does not pass the inspection, the optical element is taken out, its shape is adjusted, and the optical characteristic is re-inspected after the optical element is again mounted. After it passes the inspection, the projection optical system is finally assembled.

There are two methods of taking the optical element 2 out of the barrel 4. The first method is a method of dividing the barrel and then of taking out the optical element 2. The second method is a method of providing the opening 160 in the barrel 4, as shown in FIG. 2, and of taking out the optical element 2 through the opening 160. It is necessary to precisely place the optical element 2 at the same position in the barrel 4 before and after the takeout. The reproducibility of the position may require a precision higher than a submicron, although it depends upon the sensitivity of the optical system. When the optical element 2 is returned to a position different from the pre-takeout position, the imaging characteristic changes by the shift amount, and an improvement derived from the corrective processing is canceled out or the imaging characteristic may deteriorate at worst. The first method needs an operation that has a difficulty in precisely returning the optical element 2, and thus unsuitable for the takeout method of the optical element 2.

On the other hand, even when the second method is used, a device is necessary to maintain the positional reproducibility of the optical element 2. Therefore, this embodiment reduces the size of the opening 160. It is effective to take out only the optical element 2 from the opening 160 in the barrel 4, but it is difficult to take out only the optical element 2 because the optical element 2 is connected to the holders 110, as shown in FIG. 3, so as to shield the external forces. Accordingly, it is conceivable to take out the intermediate plate and the optical element 2 in one united body. Then, the structure proposed in JP 2005-276933 removes the end effecter and makes individual drivers (which correspond to linkages 47A-F in JP 2005-276933) structurally unstable. When the end effecter is again attached to the structurally unstable drivers, the positional reproducibility degrades.

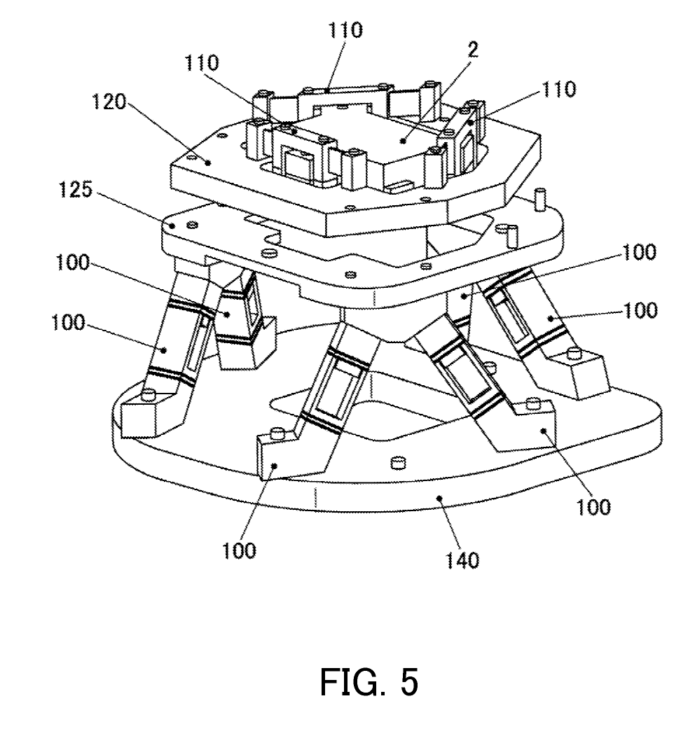

Accordingly, as shown in FIG. 5, this embodiment enables the intermediate plate to be separated into two. The first intermediate plate 120 can be taken out of the barrel 4 with the holders 110 and the optical element 2, and the second intermediate plate 125 serves to couple the drivers 100 with one another so as to maintain the rigidity of the drivers 100. The positioning pins 151 shown in FIG. 4 can be used to highly precisely guarantee the reproducibility of the attachment positions of the first intermediate plate 120 and the second intermediate plate 125.

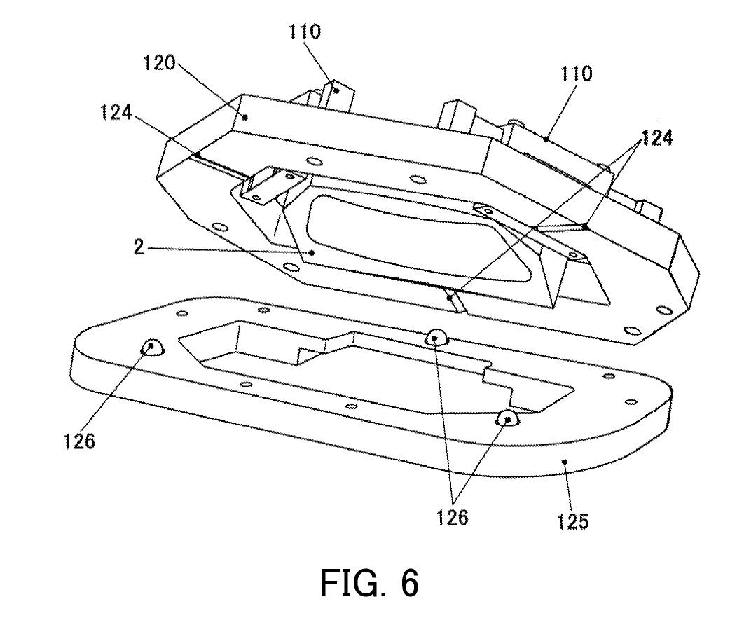

FIG. 6 uses a kinematic mount (also referred to as a Kelvin clamp) so as to provide positioning more precisely than a method of positioning the first intermediate plate 120 and the second intermediate plate 125 by using the positioning pins 151. The first intermediate plate 120 has V-shaped grooves 124 arranged at approximately regular angular intervals, the second intermediate plate 125 has three cones (which may be triangular prism holes), and each sphere 126 is provided between the V-shaped groove 124 and the cone. It is effective to provide a surface treatment (such as an attachment of a diamond like carbon thin film) that makes frictional coefficients between surfaces of the sphere 126 and the V-shaped groove 124 and the cone, each of which contact the sphere 126 as small as possible, and to use a lubricant agent if it is environmentally permissible. This configuration reduces frictional distortions that would otherwise occur due to contacts, and can expect a high positioning reproducibility. An arrangement relationship of the cone and the V-shaped groove 124 may be inverted between the first intermediate plate 120 and the second intermediate plate 125. FIG. 6 inclines the first intermediate plate 120 to the second intermediate plate 125 rather than drawing them in parallel so as to clearly show their opposing surfaces. The kinematic mount is not limited to the combination of the V-shaped groove and the cone shown in FIG. 6, and may use a V-shaped groove, a cone, and a plane, instead of three V-shaped grooves 124. The detail of the kinematic mount is described, for example, in “Foundations of Ultraprecision Mechanism Design,” supra, and thus will be omitted here.

If the sensitivity to an optical position is high, a coupling method that uses a kinematic mount may still be insufficient, because the imaging characteristic greatly changes after the optical element 2 is assembled. FIG. 7 is a sectional view taken along the A surface shown in FIG. 2, which shows the sensor heads 131 and 132 of the position measurement part (sensor) 130 configured to measure a position of the optical element 2 before and after the takeout on the basis of the barrel 4. In FIG. 7, the sensor measures a distance between the sensor heads 131 and 132 fixed onto the base plate 140 and the target attached to the optical element 2. When an electrostatic capacitance type is selected as a sensor, a positional shift amount can be monitored with a precision equal to or smaller than a submicron order before and after the takeout and the assembly of the optical element 2. The sensor may measure a distance in hexaxial directions, but the number of measurement axes may be decreased in accordance with the optical sensitivity.

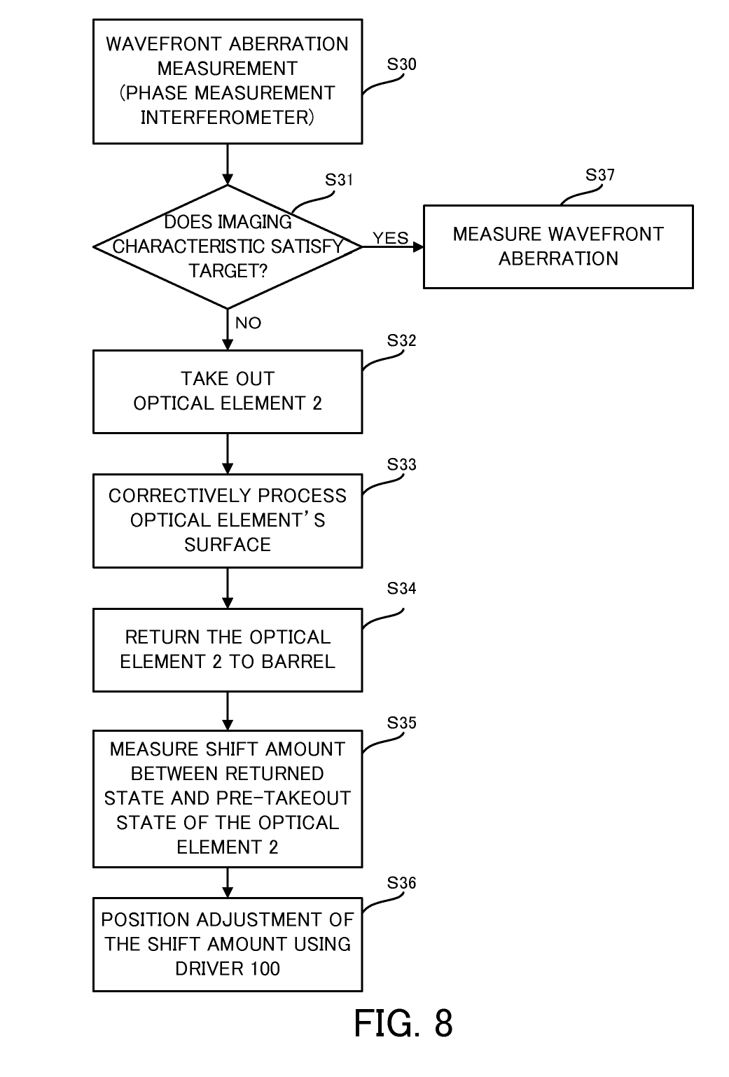

Referring now to FIG. 8, a description will be given of an adjustment method of the projection optical system 1. In FIG. 8, “S” denotes a step. Initially, assume that the projection optical system 1 is provisionally assembled. The positioning unit 3 can be remotely controlled. The controller 10 calculates an ideal position through calculations based on the evaluation result of the imaging characteristic, moves the optical element 2 via the driver 100, again measures the imaging characteristic, and can proceed with the adjustment at a comparatively short cycle. Next, the wavefront aberration of the projection optical system 1 is measured (S30). S30 measures the imaging characteristic by using a wavefront aberration measurement unit (or phase measurement interferometer) (not shown) that includes an interferometer, and optimizes the relative position of the optical element 2, etc. Next, the controller 10 determines whether the wavefront aberration of the projection optical system 1 is restrained within a set range, based on the measurement result by the measurement step S30 (S31). When the controller 10 determines that the wavefront aberration of the projection optical system 1 is not restrained within the set range (S31), the optical element 2, the holders 110, and the first intermediate plate 120 are separated from the second intermediate plate 125 and taken as one united body out of the barrel through the opening 160 in the barrel 4 (S32).

Next, the optical element 2 is correctively processed (S33). The corrective processing step S33 corrects a surface shape of the effective area EA of the optical element 2 through laser irradiations, etc. At this time, a working machine may be configured to be mounted with the first intermediate plate 120 as it is. This configuration can maintain a positional arrangement among the first intermediate plate 120, the optical element 2, and the holders 110.

Next, after the corrective processing step, the optical element 2, the holders 110, and the first intermediate plate 120 are returned in one united body to the second intermediate plate inside of the barrel 4 (S34).

Next, the controller 10 measures a shift amount between the returned state and the pre-takeout state of the optical element 2 by using the position measurement part 130 (S35). The position measurement part 130 may use one different from the electrostatic capacitance type as long as it can measure an absolute displacement. The laser interference distance-measurement unit is highly accurate but measures a relative displacement. It is therefore suitable for a sensor used for continuous servo controls of the positioning unit 3, but is not suitable for the shift measurements of the optical element 2. A linear encoder equipped with an origin signal can highly precisely measure an absolute displacement, and can serve as a sensor for the servo controls and the positional shift measurements of the optical element 2, if it can be arranged in that space.

Next, the controller 10 corrects a shift amount by using the driver 100 (S36). Thereby, the optical element 2 can be precisely returned to the pre-takeout position of the optical element 2. At this state, when the imaging characteristic is again measured by using the wavefront aberration measurement unit, the obtained wavefront results from the corrective processing of the optical element 2, and does not contain a positional shift amount of the optical element 2. As a result, it can lead to the stage of high imaging characteristic and period required to reach the stage can also be shortened. The controller 10 ends the adjustment (S37) when determining that the wavefront aberration of the projection optical system 1 is restrained within the set range (S31). Thereafter, the projection optical system 1 is finally assembled.

While this embodiment takes out the optical element 2 so as to correctively process its surface shape, the optical element 2 may be taken out for another purpose, such as a deposition on its surface. Depending upon the process to the taken-out optical element 2, the holders 110 and the first intermediate plate 120 do not have to be separated from the optical element 2. In this case, since no shift occurs in the positional relationship between the optical element 2 and the first intermediate plate 120, a shift measurement after they are returned to the barrel 4 may be applied to positions of the first intermediate plate 120 or the holders 110 rather than the optical element 2. In addition, the projection optical system 1 includes a plurality of positioning units 3, but when the optical element 2 does not have to be taken out of the barrel 4 in the adjustment process of the wavefront aberration measurement unit, the intermediate plate 120 does not have to be configured dividable for space saving in the barrel 4.

While this embodiment applies the positioning unit to the projection optical system in the exposure apparatus, the positioning unit according to the present invention may be applied to another optical element, such as an illumination optical system in the illumination apparatus.

In exposure, the EUV light emitted from the light source in the illumination apparatus (not shown) uniformly illuminates the original 7 in an arc shape via the illumination optical system in the illumination apparatus (not shown). The EUV light that reflects the pattern of the original is projected onto the substrate 5 via the projection optical system 1. Since the flow shown in FIG. 8 improves the imaging characteristic of the projection optical system 1 in the exposure apparatus of this embodiment, the exposure apparatus can exhibit a high-quality resolition characteristic. A device, such as a semiconductor integrated circuit device or a liquid crystal display device, is manufactured by a device manufacturing method that includes the step of exposing a photosensitive agent applied substrate (such as a wafer or a glass plate) by using the above exposure apparatus, the step of developing the substrate, and another well-known step.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-088793, filed Mar. 28, 2008, which is hereby incorporated by reference herein in its entirety.

What is claimed is:

1. A positioning unit configured to position an optical element in a barrel, the positioning unit comprising:
a holder configured to hold the optical element;
a first intermediate plate mounted with the holder;
a second intermediate plate configured to support the first intermediate plate;
a plurality of drivers each configured to drive the second intermediate plate with respect to a plurality of axes, and each fixed inside of the barrel; and
a positioning part configured to position the first intermediate plate relative to the second intermediate plate,
wherein the second intermediate plate couples ends of the plurality of drivers with one another.

2. A positioning unit according to claim 1, wherein the positioning part is a kinematic mount or a positioning pin.

3. A positioning unit according to claim 1, further comprising a fixing part configured to fix the first intermediate plate onto the second intermediate plate.

4. A positioning unit according to claim 1, further comprising a position measurement part configured to measure a position of the optical element.

5. A positioning unit according to claim 1, wherein each driver includes a parallel linkage.

6. A positioning unit configured to position an optical element in a barrel, the positioning unit comprising:
a holder configured to hold the optical element;
a first intermediate plate, onto which the holder is fixed;
a second intermediate plate configured to support the first intermediate plate; and
a driver configured to drive the second intermediate plate, one end of the driver being fixed onto the second intermediate plate, and another end of the driver being fixed onto the barrel,
wherein the optical element, the holder, and the first intermediate plate can be separated in one united body from the second intermediate plate.

7. An optical unit comprising:
an optical element;
a holder configured to hold the optical element; and
a first intermediate plate, onto which the holder is fixed,
wherein the optical unit can be separated in one united body from a second intermediate plate, and
wherein the second intermediate plate is driven by a driver, one end of the driver being fixed onto the second intermediate plate, and the other end of the driver being fixed onto a barrel.

8. An optical system comprising:
an optical element;
a barrel configured to house the optical element; and
a positioning unit configured to position the optical element in the barrel,
wherein the positioning unit includes:
a holder configured to hold the optical element;
a first intermediate plate mounted with the holder;
a second intermediate plate configured to support the first intermediate plate;
a plurality of drivers each configured to drive the second intermediate plate with respect to a plurality of axes, and each fixed inside of the barrel; and
a positioning part configured to position the first intermediate plate relative to the second intermediate plate, and
wherein the second intermediate plate couples ends of the plurality of drivers with one another.

9. An optical system according to claim 8, wherein the barrel has an opening through which the optical element, the holder, and the first intermediate plate in one united body can be put in and out of the barrel, the opening being too small to put a whole positioning unit in and out of the barrel through the opening.

10. An exposure apparatus comprising an optical system that includes:
an optical element;
a barrel configured to house the optical element; and
a positioning unit configured to position the optical element in the barrel,
wherein the positioning unit includes:
a holder configured to hold the optical element;
a first intermediate plate mounted with the holder;
a second intermediate plate configured to support the first intermediate plate;
a plurality of drivers each configured to drive the second intermediate plate with respect to a plurality of axes, and each fixed inside of the barrel; and
a positioning part configured to position the first intermediate plate relative to the second intermediate plate, and
wherein the second intermediate plate couples ends of the plurality of drivers with one another.

11. An exposure apparatus comprising a positioning unit configured to position an optical element in a barrel,
wherein the positioning unit includes:
a holder configured to hold the optical element;
a first intermediate plate, onto which the holder is fixed;
a second intermediate plate configured to support the first intermediate plate; and
a driver configured to drive the second intermediate plate, one end of the driver being fixed onto the second intermediate plate, and another end of the driver being fixed onto the barrel, and
wherein the optical element, the holder, and the first intermediate plate can be separated in one united body from the second intermediate plate.

12. A device manufacturing method comprising the steps of:
exposing a substrate using an exposure apparatus; and
developing a substrate that has been exposed,
wherein the exposure apparatus includes an optical element, a barrel configured to house the optical element, and a positioning unit configured to position the optical element in the barrel,
wherein the positioning unit includes a holder configured to hold the optical element, a first intermediate plate mounted with the holder, a second intermediate plate configured to support the first intermediate plate, a plurality of drivers each configured to drive the second intermediate plate with respect to a plurality of axes, and each fixed inside of the barrel, and a positioning part configured to position the first intermediate plate relative to the second intermediate plate, and
wherein the second intermediate plate couples ends of the plurality of drivers with one another.

13. A device manufacturing method comprising the steps of:
exposing a substrate using an exposure apparatus; and
developing a substrate that has been exposed,
wherein the exposure apparatus includes a positioning unit configured to position an optical element in a barrel,
wherein the positioning unit includes a holder configured to hold the optical element, a first intermediate plate, onto which the holder is fixed, a second intermediate plate configured to support the first intermediate plate, and a driver configured to drive the second intermediate plate, one end of the driver being fixed onto the second intermediate plate, and another end of the driver being fixed onto the barrel, and
wherein the optical element, the holder, and the first intermediate plate can be separated in one united body from the second intermediate plate.

14. An adjustment method of an optical system that includes an optical element, a barrel configured to house the optical element, and a positioning unit configured to position the optical element in the barrel, wherein the positioning unit includes a holder configured to hold the optical element, a first intermediate plate mounted with the holder, a second intermediate plate configured to support the first intermediate plate, a plurality of drivers each configured to drive the second intermediate plate with respect to a plurality of axes, and each fixed inside of the barrel, and a positioning part configured to position the first intermediate plate relative to the second intermediate plate, wherein the second intermediate plate couples ends of the plurality of drivers with one another, wherein the barrel has an opening through which the optical element, the holder, and the first intermediate plate in one united body can be put in and out of the barrel, the adjustment method comprising the steps of:
measuring an wavefront aberration of the optical system;
determining, based on a measurement result of the measuring step, whether the wavefront aberration of the optical system is restrained in a set range;
separating the optical element, the holder, and the first intermediate plate from the second intermediate plate and taking the optical element, the holder, and the first intermediate plate in one united body out of the barrel through the opening of the barrel, when the determining step determines that the wavefront aberration of the optical system is not restrained in the set range;
correctively processing the optical element;
returning the optical element, the holder, and the first intermediate plate in one united body to the second intermediate plate in the barrel, after the corrective processing step;
measuring a shift amount between a returned state and a pre-takeout state of the optical element; and
correcting the shift amount using the driver.
